(19) United States
(12) Patent Application Publication
(10) Pub. No.: US 2018/0088969 A1
(43) Pub. Date: Mar. 29, 2018

(54) METHOD AND DEVICE FOR PRESENTING INSTRUCTIONAL CONTENT

(71) Applicant: Lenovo (Singapore) Pte. Ltd., New Tech Park (SG)

(72) Inventors: Russell Speight VanBlon, Raleigh, NC (US); Scott Wentao Li, Cary, NC (US); Robert James Kapinos, Durham, NC (US); Timothy Winthrop Kingsbury, Cary, NC (US)

(21) Appl. No.: 15/278,901

(22) Filed: Sep. 28, 2016

(51) Int. Cl. G06F 9/44; G06F 17/27; G06F 3/01; G06F 3/0482; G09B 5/02

(52) U.S. Cl. CPC G06F 9/4446; G06F 17/2705; G09B 5/02; G06F 3/0482; G06F 3/013

(57) ABSTRACT

A computer implemented method, device and computer program product are provided for presenting instructional content. The method automatically identifies instructional content utilizing one or more processors of the device. The method further comprises parsing the instructional content to identify a set of content subsections, and receiving, through a user interface of the device, a user request associated with the set of content subsections. The method presents at least a portion of the set of content subsections, through a user interface of the device, in a user directed manner based on the user request.

### BACKGROUND

Embodiments of the present disclosure generally relate to methods and devices for presenting instructional content.

Today, a vast amount of information is available through electronic sources such as through browser-based searches, social media and the like. Individuals use electronic sources for a variety of reasons, many of which relate to obtaining instructional resources related to various activities. Examples of instructional resources include Internet sites that provide cooking recipes, do-it-yourself home repair, automotive repair, educational instructions, assembling toys, furniture and the like. Currently, various types of devices and search tools are offered to search for and review the instructional resources. Examples of devices and search tools include smart phones, tablet devices, and laptop computers that operate browsers, social media, applications, etc.

However, conventional devices and search tools do not facilitate use while also attempting to follow the instructions and conduct the related activity. For example, when a person is cooking, the person may navigate a smartphone web browser to a webpage that includes a recipe with a series of instructions. In order to follow the recipe on the smart phone, the individual repeatedly handles the phone to turn on the display and scroll through the recipe (referring back and forth to the different sections). When a person is working on a vehicle, the person also must repeatedly pick up and turn on their phone, and scroll through the instructions, while performing the corresponding repair activities. In each of the foregoing examples, the person is doing another activity that involves their hands, and thus it is not convenient to repeatedly manually access the smart phone, tablet device and the like.

Some electronic devices offer applications that include a reader configured to read the text from a display. However, conventional text readers typically read through the information in a continuous narrative, thereby reading all of the text from the webpage at one continuous time. The readers do not distinguish between instructions and other content on the page and thus read a large amount of information that is not part of the instructions. Reading non-recipe information along with the complete recipe all at once, is not constructive, when the person is attempting to perform the steps in parallel with the spoken text. While conventional text readers may be paused, it is still inconvenient for the person to manually or verbally instruct the device to pause and restart. The person may also wish to have earlier instructions repeated. Conventional readers lack knowledge of the content on the page and are not able to repeat particular instructions.

A need remains for methods, devices and program products that present instructional content in a manner that overcomes the foregoing and other disadvantages.

### SUMMARY

In accordance with embodiments herein, a computer implemented method is provided for presenting instructional content. The method automatically identifies instructional content utilizing one or more processors of the device. The method further comprises parsing the instructional content to identify a set of content subsections, and receiving, through a user interface of the device, a user request associated with the set of content subsections. The method presents at least a portion of the set of content subsections, through a user interface of the device, in a user directed manner based on the user request.

Optionally, the method may display the instructional content on a display of an electronic device. The automatically identifying may comprise analyzing the instructional content being displayed, utilizing one or more processors of the device. The user directed manner may include introducing a delay between presenting first and second content subsections from the set of content subsections in response to the user request. The set of content subsections may be organized in a predetermined order. The user directed manner may include designating a content subsection of interest from the set of the content subsections. The content subsection of interest may be presented out of order based on the user request. The user request may designate a content subsection of interest from the set of content subsections to be repeated outside of a predetermined order. The parsing may comprise applying a filter to the instructional content to identify the set of content subsections.

Optionally, the method may further comprise activating an instructional support mode based on one or more activation events. The parsing, receiving and presenting may be performed during the instructional support mode. The one or more activation events may comprise determining whether a location of the device corresponds to a predetermined area. The instructional support mode may be activated based on the determining.

Optionally, the method may further activate an instructional support mode based on one or more activation events. The parsing, receiving and presenting may be performed during the instructional support mode. The one or more in activation events may comprise identifying whether the device is presenting at least a portion of the instructional content. The instructional support mode may be activated based on the identifying.

Optionally, the method may further comprise activating an instructional support mode based on one or more activation events. The parsing, receiving and presenting may be performed during the instructional support mode. The one or more activation events may comprises identifying a user gaze relative to the display of the device. The instructional support mode may be activated based on the identifying.

In accordance with embodiments herein, a device is provided. The device comprises a processor and memory storing program instructions accessible by the processor. Responsive to execution of the program instructions, the processor automatically identifies instructional content utilizing one or more processors of the device, parses the instructional content to identify a set of content subsections, receives a user request associated with the set of content subsections and presents at least a portion of the set of content subsections, through a user interface of the device, in a user directed manner based on the user request.

Optionally, the device may further comprise a display configured to display the instructional content. The processor may be configured to analyze the instructional content being displayed. The processor may introduce a delay between presenting first and second content subsections from the set of content subsections, a duration of the delay based on the user request. The processor may be configured to organize the set of content subsections in a predetermined order. The processor may be configured to present a content subsection of interest from the set of content subsections out of order based on the user request.

Optionally, the user request may designate a content subsection of interest from the set of content subsections to be repeated outside of a predetermined order. The processor may be configured to repeat the content subsection of interest. The device may further comprise a GPS chipset configured to determine a location of the device. The processor may be configured to determine when the location of the device corresponds to a predetermined area associated with activating an instructional support mode. A camera may be configured to obtain image data frames. The processor may be configured to identify a user gaze relative to a display of the device based on the image data frames and activate an instructional support mode based on the user gaze.

In accordance with embodiments herein, a computer program product is provided comprising a non-signal computer readable storage medium comprising computer executable code to perform: automatically identifying instructional content utilizing one or more processors of a device, parsing the instructional content to identify a set of content subsections, receiving, through a user interface of the device, a user request associated with the set of content subsections and presenting at least a portion of the set of content subsections, through a user interface of the device, in a user directed manner based on the user request.

Optionally, the computer program product may comprise a list of instructional resources representing network locations that provide instructional content for one or more types of activities, the automatic identifying comparing compare an accessed resource to the list of instructional resources. Region location data may define one or more predetermined areas that are designated as active instructional support areas. The set of content subsections may be organized in a predetermined order. The user directed manner may include designating a content subsection of interest from the set of the content subsections. The content subsection of interest may be presented out of order based on the user request.

### BRIEF DESCRIPTION OF THE DRAWINGS

FIG. 1 illustrates an overview of a device implemented in accordance with embodiments herein.

FIG. 2 illustrates a simplified block diagram of the device in accordance with embodiments herein.

FIG. 3 illustrates a process carried out in accordance with embodiments for presenting instructional content in accordance with an embodiment herein.

FIG. 4 illustrates a process for determining when to activate an instructional support mode based on GPS information and browser content in accordance with embodiments herein.

FIG. 5 illustrates an alternative process for determining whether to activate an instructional support mode based on device position and gaze events in accordance with embodiments herein.

FIG. 6A illustrates an example of a webpage that may be accessed in connection with obtaining instructional content in accordance with an embodiment herein.

FIG. 6B illustrates an example of an electronic device presenting a content subsection in accordance with an embodiment herein.

FIG. 6C illustrates an example of an electronic device presenting a content subsection in accordance with an embodiment herein.

FIG. 7A illustrates alternative embodiments in which the methods and devices described herein are implemented in connection with various types of devices.

FIG. 7B illustrates alternative embodiments in which the methods and devices described herein are implemented in connection with various types of devices.

### DETAILED DESCRIPTION

It will be readily understood that the components of the embodiments as generally described and illustrated in the FIGS. herein, may be arranged and designed in a wide variety of different configurations in addition to the described example embodiments. Thus, the following more detailed description of the example embodiments, as represented in the FIGS., is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

It should be clearly understood that the various arrangements and processes broadly described and illustrated with respect to the FIGS., and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

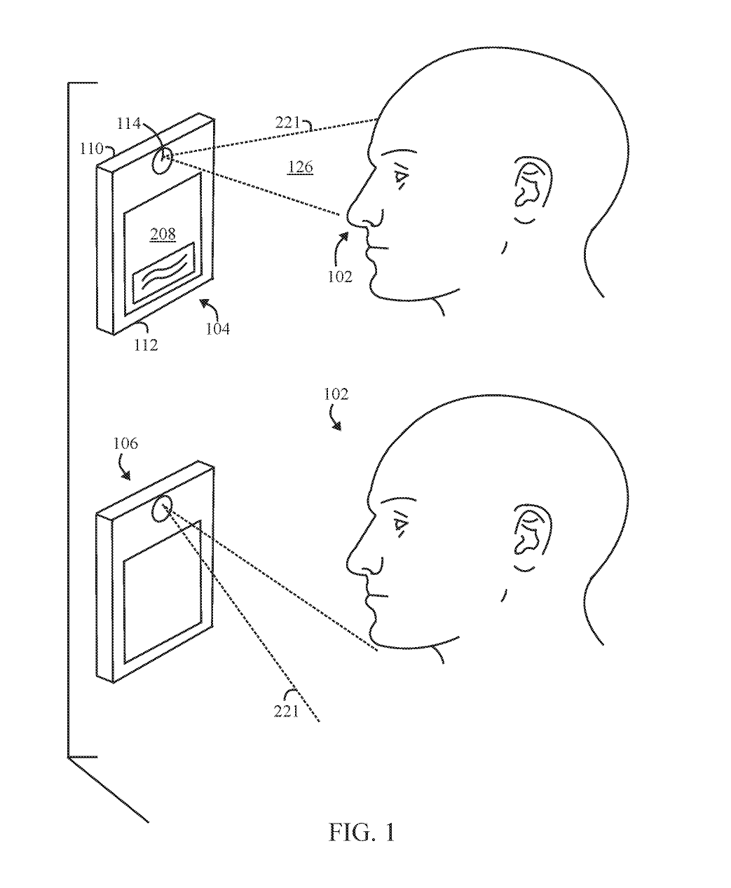

FIG. 1 illustrates an overview of a device implemented in accordance with embodiments herein. FIG. 1 illustrates a device 110 that may be held by a user proximate to a user face 102 such as when the user is engaged in viewing the display of the device 110 (generally referred to as an engaged position 104). The device 110 may also be located remote from the user face 102, such as when the user is not viewing the display (generally referred to as a disengaged position 106).

The device 110 includes a user interface 208 to display various types of information to the user and to receive inputs from the user. The user interface 208 supports interaction with various applications, browsers, the OS and the like. The device 110 also includes a digital camera to take still and/or video images. The device 110 includes a housing 112 that includes at least one side, within which is mounted a lens 114 of the digital camera. Optionally, the camera unit may represent another type of camera unit other than a digital camera. The lens 114 has a field of view 221 and operates under control of the digital camera unit in order to capture image data for a scene 126. When the device 110 is held in the engaged position 104, the user face 102 is located within the field of view 221. When the device 110 is held in the disengaged position 106, the user face 102 is located outside of the field of view 221. As explained herein, movement between the engaged and disengaged positions 104, 106 may be used to activate an instructional support mode.

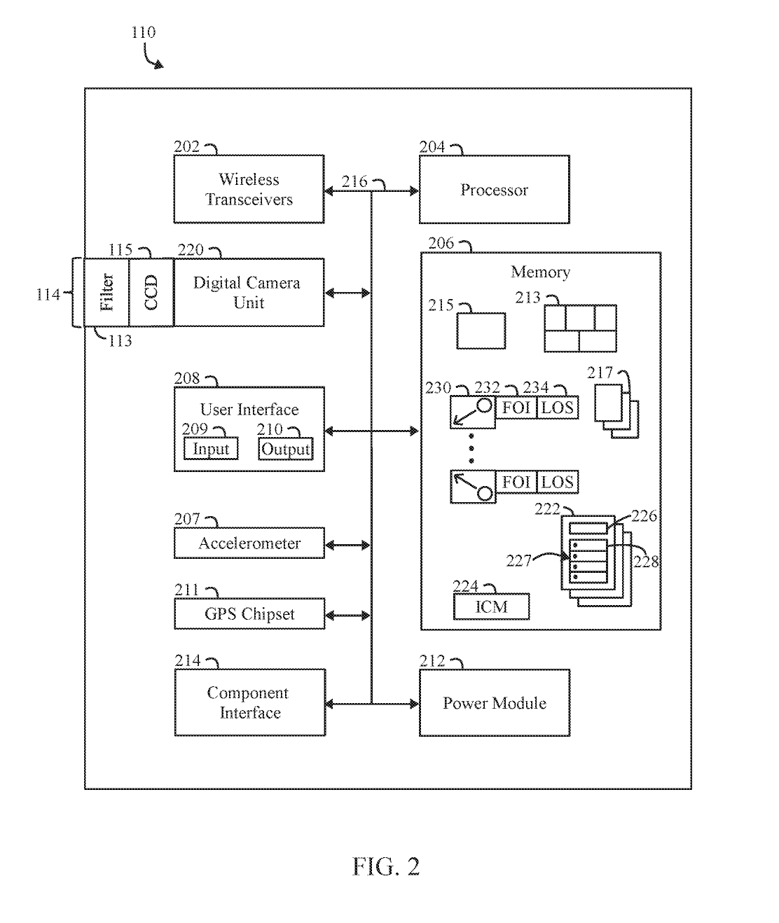

FIG. 2 illustrates a simplified block diagram of the device 110, which includes components such as one or more wireless transceivers 202, one or more processors 204 (e.g., a microprocessor, microcomputer, application-specific integrated circuit, etc.), one or more local storage medium (also referred to as a memory) 206, a GPS chipset 211, the user interface 208 which includes one or more input devices 209 and one or more output devices 210, an accelerometer 209, a power module 212, a digital camera unit 220, and a component interface 214. All of these components can be operatively coupled to one another, and can be in communication with one another, by way of one or more internal communication links 216, such as an internal bus.

The housing 112 of the device 110 holds the processor(s) 204, memory 206, user interface 208, the digital camera unit 220 and other components. The digital camera unit 220 may further include one or more filters 113 and one or more detectors 115, such as a charge coupled device (CCD). The detector 115 may be coupled to a local processor within the digital camera unit 220 that analyzes image frame data captured.

The input and output devices 209, 210 may each include a variety of visual, audio, and/or mechanical devices. For example, the input devices 209 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Among other things, the microphone may be utilized to record spoken requests from the user. Similarly, the output devices 210 can include a visual output device such as a liquid crystal display screen, one or more light emitting diode indicators, an audio output device such as a speaker, alarm and/or buzzer, and a mechanical output device such as a vibrating mechanism. Among other things, the speaker may be used to state instructions, ask questions and otherwise interact with the user. The display may be touch sensitive to various types of touch and gestures. As further examples, the output device(s) 210 may include a touch sensitive screen, a non-touch sensitive screen, a text-only display, a smart phone display, an audio output (e.g., a speaker or headphone jack), and/or any combination thereof. The user interface 208 permits the user to select one or more of a switch, button or icon in connection with normal operation of the device 110.

The memory (local storage medium) 206 may encompass one or more memory devices of any of a variety of forms (e.g., read only memory, random access memory, static random access memory, dynamic random access memory, etc.) and can be used by the processor 204 to store and retrieve data. The data that is stored by the memory 206 can include, but need not be limited to, operating systems, applications, instructional content and informational data. Each operating system includes executable code that controls basic functions of the communication device, such as interaction among the various components, communication with external devices via the wireless transceivers 202 and/or the component interface 214, and storage and retrieval of applications and data to and from the memory 206. Each application includes executable code that utilizes an operating system to provide more specific functionality for the communication devices, such as file system service and handling of protected and unprotected data stored in the memory 206.

Applications stored in the memory 206 include various application program interfaces (APIs). Additionally, the applications stored in the memory 206 include an instructional content management (ICM) application 224 for facilitating identification, parsing, management and presentation of instructional content on the device 110, thereby permitting the device 110 to present at least a portion of a set of content subsections, through the user interface of the device, and a user directed manner based on user request. The ICM application 224 provides the foregoing functionality without requiring the user to manually touch the user interface or physically enter a series of inputs to the device 110. The ICM application 224 includes program instructions accessible by the processor 204 to direct the processor 204 to implement the methods, processes and operations described herein, and illustrated and described in connection with the FIGS.

As explained herein, the memory 206 stores information and data of interest. For example, the memory 206 stores device location information 215 associated with a current location of the device and region location data 213 that defines one or more predetermined areas that are designated as candidate/active instructional support areas. For example, the region location data 213 may represent boundaries of a geographic area (GPS coordinate boundaries). Additionally or alternatively, the region location data 213 may represent a GPS reference/center coordinate alone or in combination with range information. During operation, current device location information 215 is obtained by the GPS module 211. The device location information 215 is compared (at the processor 204) with the region location data 213 to determine whether an activation event has occurred. For example, an activation event may occur when the device is positioned within a predetermined geographic boundary and/or within a predetermined distance (as defined by the range information) from a GPS reference coordinate.

The memory 206 may also stores a list of instructional resources 217 representing resource locations that provide instructional content for one or more types of activities. The memory 206 may record instruction resources 217 as part of the user history, favorites, user profile or otherwise. The resource locations may correspond to particular websites, domains, links, social media designators and other links like that are associated with sources from which the user has or desires to obtain instructional content. The list of instructional resources 217 may be saved or updated by the user during operation of the ICM application 224. Additionally or alternatively, the list of instructional resources 217 may be uploaded with installation of the ICM application and/or throughout operation. During operation, when a user operates a browser, application, social media link or otherwise, the ICM application 224 directs the processor 204 to compare each accessed resource to the list of instructional resources 217. When a match occurs, the match may represent one example of an activation event that may be utilized to direct the ICM application 224 to enter an instructional support mode.

The memory 206 also stores image data frames 230, along with corresponding feature of interest (FOI) position data 232 and line of sight (LOS) data 234. The image data frames 230 may be captured periodically by the camera within the device, such as in connection with obtaining snapshots of the user's face. The image data frames 230 are analyzed by the processor 204, in connection with gaze detection, to identify FOI position data 232 and LOS data 234. The FOI position data 232 may correspond to the eyes of the user, while the LOS data 234 corresponds to the direction in which the user has focused his or her attention. By comparing the LOS data 234 in connection with different image data frames 230, in accordance with embodiments herein, gaze detection may be used to determine when a user is viewing the display (during one image data frame 230) and then moves the user's line of sight away from the display (in the next image data frame 230).

The memory 206 also stores application content and/or webpages 222 that are accessed by the device during a browser session. The webpage 222 may include various types of content including general content 226 and instructional content 227. In accordance with embodiments herein, the webpage 222 is parsed to distinguish between the general content 226 and the instructional content 227 within the webpage 222. The instructional content 227 is further parsed to identify a set of content subsections 228 that collectively form a set of instructions associated with a particular type of instructional activity. As one example, a webpage 222 may be accessed on a recipe related website. The webpage 222 may be parsed to identify the instructional content 227 which corresponds to the actual recipe. The instructional content 227 is further parsed to identify the set of content subsections 228 which may represent individual steps or actions to be performed in connection with following the recipe.

The ICM application 224 is preferably activated by default when select criteria occur (as discussed herein), and can be activated or disabled via input devices 209 of the user interface 208. In one embodiment, the ICM application 224 may be automatically activated when one or more activation occur, such as the device 110 being used to navigate to instructional content, the device 110 placed in a predetermined position/orientation (e.g., set on side or end edge), the device 110 located in a predetermined area (e.g., kitchen), the device 110 moved in a predetermined gesture pattern, and the like. The ICM application 224 includes program instructions accessible by the processor 204 to direct the processor 204 to implement the methods, processes and operations described herein, and illustrated and described in connection with the FIGS.

In accordance with gaze detection, the ICM application 224 analyzes the image frame data 230 captured by the digital camera unit 220 to detect facial features, eye movement, line of sight of the eyes and the like. In accordance with embodiments herein, the digital camera unit 220 collects a series of image data frames 230 associated with the scene 126 over a select period of time. For example, the digital camera unit 220 may begin capturing the image data frames 230 when a notification is presented on the display, and continue capturing for a predetermined period of time.

The processor 204, under control of the ICM application 224, analyzes one or more image data frames 230, to detect a position of one or more features of interest (e.g., nose, mouth, eyes, glasses, eyebrows, hairline, cheek bones) within the image data frames 230. The positions of the features of interest are determined from the image data frames, where the position is designated with respect to a coordinate reference system (e.g., an XYZ reference point in the scene, or with respect to an origin on the face). The processor 204 records, in the memory 206, FOI position data 232 indicating a location of each feature of interest, such as relative to a reference point within an individual image data frame 230. The FOI position data 232 may include additional information regarding the feature of interest (e.g., left eye, whether the user is wearing glasses, right eye, whether the user has sunglasses, etc.).

The processor 204, under the control of the ICM application 224, also determines the line of sight associated with one or more eyes that represent features of interest, and generates LOS data 234 based thereon. The LOS data 234 may represent a gaze direction vector defined with respect to a coordinate system. The LOS data 234 is saved in the memory 206 in combination with the FOI position data 232 and corresponding image data frames 230.

The power module 212 preferably includes a power supply, such as a battery, for providing power to the other components while enabling the device 110 to be portable, as well as circuitry providing for the battery to be recharged. The component interface 214 provides a direct connection to other devices, auxiliary components, or accessories for additional or enhanced functionality, and in particular, can include a USB port for linking to a user device with a USB cable.

The GPS chipset 211 obtains GPS location information concerning the present position of the device. Additionally or alternatively, location information may be obtained separate and apart from GPS location. For example, location information may be based on detecting a particular wireless router, based on other surrounding wireless devices and the like. The accelerometer 207 detects movement and orientation of the device 110. The accelerometer 207 may be configured to detect movement of the device 110 along predetermined gesture patterns.

The transceiver 202 may utilize a known wireless technology for communication. Exemplary operation of the wireless transceivers 202 in conjunction with other components of the device 110 may take a variety of forms and may include, for example, operation in which, upon reception of wireless signals, the components of device 110 detect communication signals and the transceiver 202 demodulates the communication signals to recover incoming information, such as voice and/or data, transmitted by the wireless signals. After receiving the incoming information from the transceiver 202, the processor 204 formats the incoming information for the one or more output devices 210. Likewise, for transmission of wireless signals, the processor 204 formats outgoing information, which may or may not be activated by the input devices 209, and conveys the outgoing information to one or more of the wireless transceivers 202 for modulation to communication signals. The wireless transceiver(s) 202 convey the modulated signals to a remote device, such as a cell tower or a remote server (not shown).

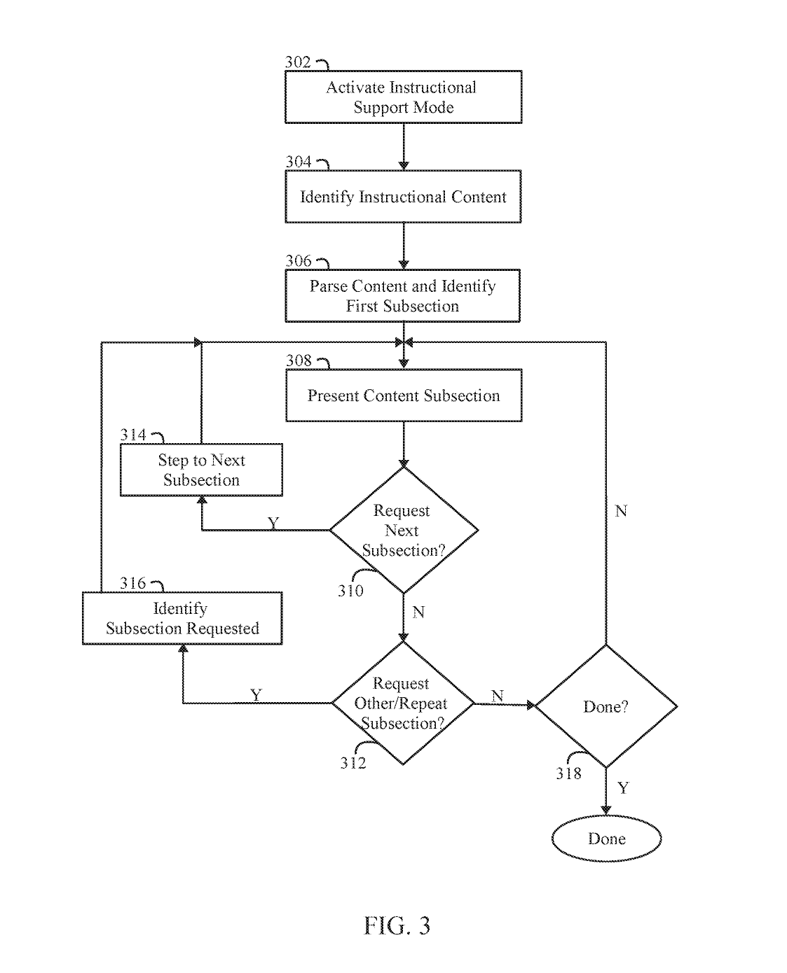

FIG. 3 illustrates a process carried out in accordance with embodiments for presenting instructional content in accordance with an embodiment herein. The operations of FIG. 3 are carried out by one or more processors 204 of the device 110 in response to execution of program instructions, such as in the ICM application 224, and/or other applications stored in the memory 206. The present example related to following a recipe. Optionally, the methods and systems described herein may be implements with other activities such as do-it-yourself home repair, automotive repair, educational instructions, assembling toys, furniture and the like.

At 302, one or more processors of the device determines to activate an instructional support mode. As explained herein, the instructional support mode may be activated based on various activation events. For example, the user may speak a direction “Start Instruction Mode”. The instructional support mode may be activated based on one or a combination of activation events. An example activation event is when the present location of the device corresponds to a predetermined area (e.g., kitchen, garage, classroom, piano, home designated study area, etc.). Additionally or alternatively, the device may determine that the device has been set down, in a particular orientation, stationery for a predetermined period of time, moved in a predetermined gesture motion. Additionally or alternatively, the device may determine that a user's gaze was initially focused on the display of the device but now has moved away from the display. Additionally or alternatively, the device may determine that a browser or application on the device has navigated to a particular webpage that contains instructional content (e.g., a recipe, a do-it-yourself list, a video clip for solving a homework problem, and the like). When one or more of the foregoing, or alternative or additional activation events are determined, the instructional support mode is activated.

At 304, the one or more processors analyzes the content presently being accessed through a web browser, social media tool, or other application, and identifies instructional content therein. At 306, the one or more processors parses through the instructional content to identify individual instructions within content subsections within the instructional content.

The identification of instructional content and/or the parsing of the instructional content may be performed in various manners. For example, the processor may search for keywords or key phrases, commonly used to start a series of instructions, such as “Preheat the oven”, “Directions”, “Perform the following operations”, and the like. Additionally or alternatively, the processor may identify the beginning and end of the instructional content (and/or subsections) based on the format of the information presented, such as by identifying numbered statements, bullet items, separate paragraphs and the like. Optionally, the processor may identify instructional content based on input from the user. For example, the user may designate a beginning and/or end of the instructions to be followed by touching the display at select points. Optionally, the instructional content and/or subsections may be identified based on metadata provided with the content, subtitles provided with videos, step related operations or otherwise. As another example, various predetermined filters (e.g., keyword or format) may be applied to the instructional content and/or subsections in order to identify individual instructions within the content.

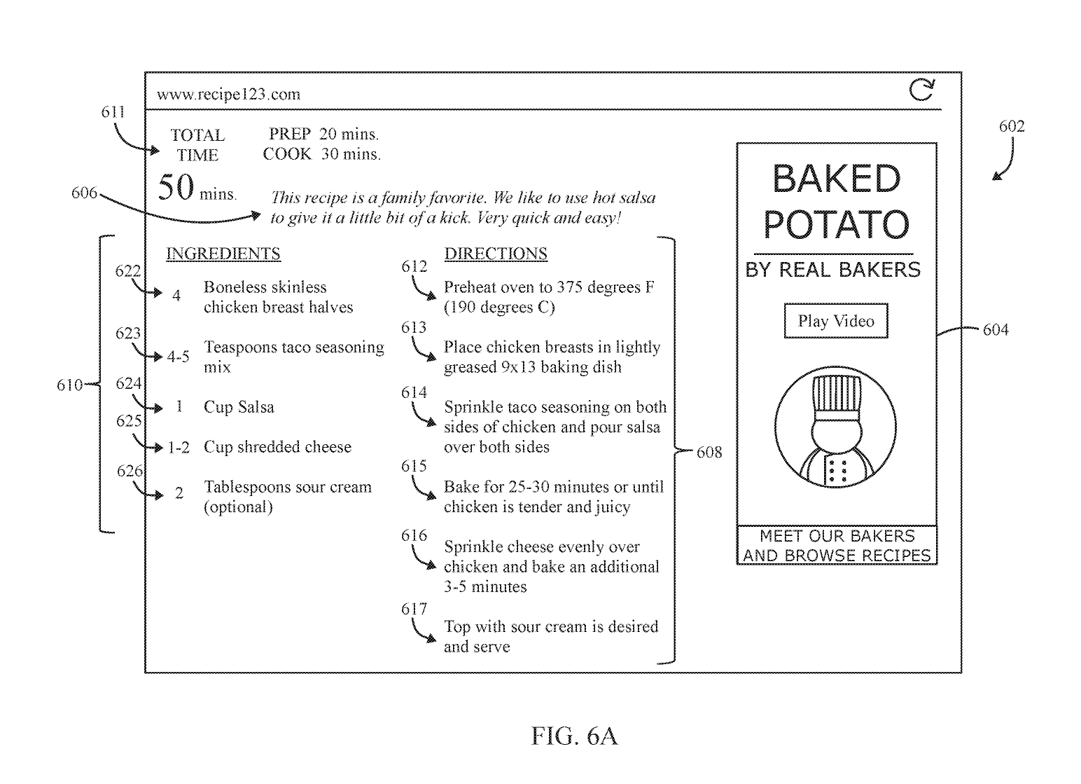

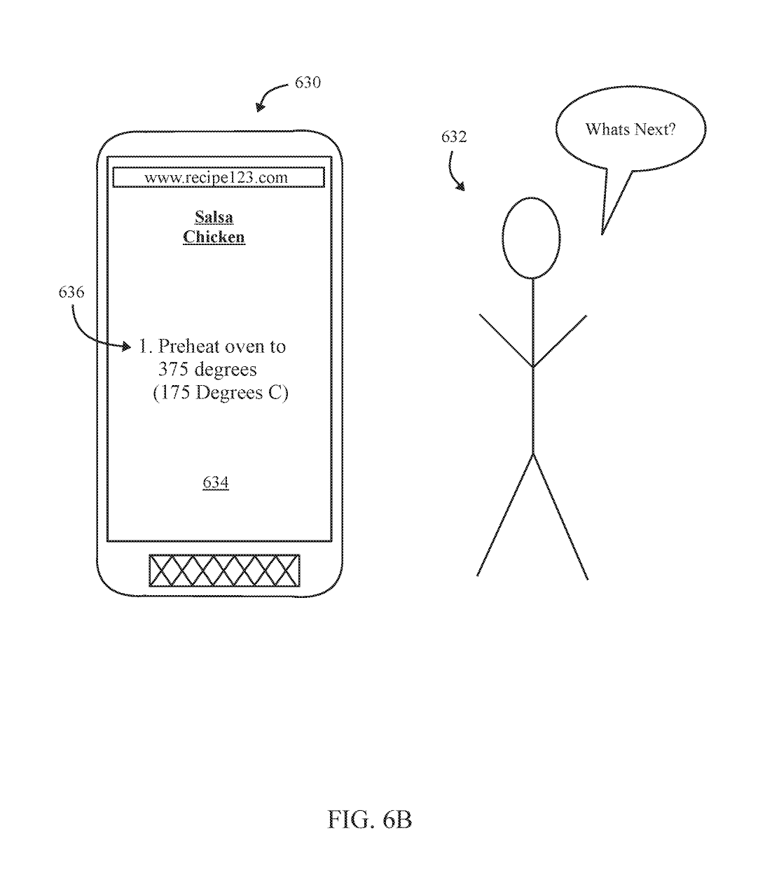

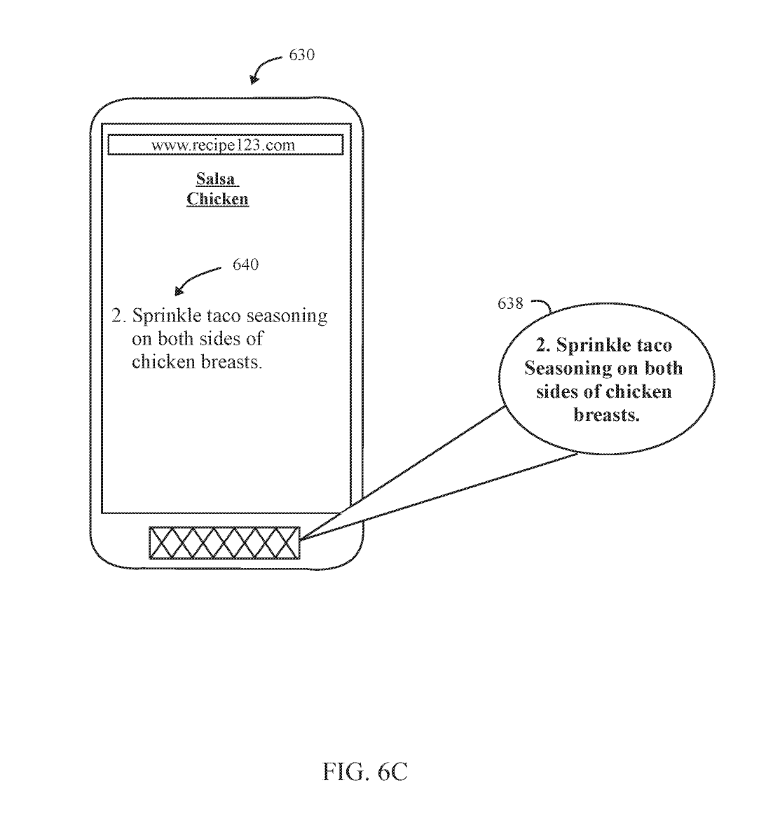

FIG. 6A illustrates an example of a webpage 602 that may be accessed in connection with obtaining instructional content in accordance with an embodiment herein. The webpage 602 is presented in a browser or other application. The webpage 602 may include various sections, such as advertisement content 604, general marketing content 606, instructional content 608, preparation or background content 610 (e.g., ingredients, tools, materials), general overview information 611, reviews, ratings and the like. As explained herein, the ICM application 224 identifies one or more of the types of content of interest. For example, the user may only desire to hear or see the instructional content 608, such as when performing the activities to follow a recipe while cooking.

Various types of parsers may be utilized to segment the webpage 602 into the corresponding portions and identify the content of interest. For example, various HTML parsers may be configured to identify particular types of content on the webpage 602. During a parsing operation, the webpage 602 may be segmented into different content types. The contents types not of interest may simply be ignored. Optionally, one or more filters may be applied to identify the content of interest. For example, predetermined formatting filter may be utilized to identify subsections of the instructional content 608 (e.g., each bullet, numbered paragraph, beginning of a paragraph). Additionally or alternatively, terminology filters may be utilized to identify subsections of the instructional content 608.

In the present example, text within the instructional content 608 is the only type of content of interest. Consequently, general marketing content 606, advertisement content 604, hyperlinks, graphical information, photographs of food items, and the like would be ignored or segmented and separated. In the example of FIG. 6A, the segmentation would retain the instructional content. Once the instructional content 608 is analyzed, each individual content subsection 612-617 is separated and recorded as a separate content subsection. The order of the content subsections 612-617 is maintained.

Additionally or alternatively, the user may only desire to hear or see preparation or the background content 610. For example, the user may only desire to see the preparation or background content 610 while shopping for the ingredients to be used in the recipe. When the background content 610 represents the content of interest, the background content 610 may be identified from a parsing operation. Content subsections 622-626 within the background content 610 may be separately identified based on formatting, based on keyword searches and the like. The background content may be separated into content subsections 622-626, each of which corresponds to a separate ingredient within the recipe. In the present example, a user may pull up the ingredient list (e.g., on a smart phone) while at a grocery store. The separate ingredients within be presented (e.g., spoken or displayed) to the user while shopping.

Returning to FIG. 3, at 308, a first content subsection is presented to the user. The content subsection may be presented in various manners, such as by displaying the content subsection on the device, audibly speaking the content subsection, playing a musical content subsection (e.g., when being used in connection with learning to play an instrument), playing a video clip as an content subsection and the like.

FIGS. 6B and 6C illustrate an example of an electronic device presenting a content subsection in accordance with an embodiment herein. The device 630 is illustrated as a smartphone and operates in response to audible requests. For example, the device 630 may present on the display 634 an initial content subsection 636, such as providing an instruction to preheat an oven to a desired temperature. The user 632 may then ask “What is next” as a user request. In response thereto, as shown in FIG. 6B, the device 630 displays the next instruction as content subsection 640. Additionally or alternatively, the device 630 may verbally state the next content subsection as noted at 638.

Optionally, the content subsections may be present in pop-up windows displayed (e.g., in a web browser) on a display of various types of device with text, images, audio, video or other information therein. Additionally or alternatively, the content subsections may be presented as a series of thumbnail images (e.g., steps 1-5). The user may touch or speak the number for the thumbnail image. When a thumbnail image is selected, the corresponding content subsection may be presented in various manners and then later or automatically collapsed back to the thumbnail image.

A current content subsection may continue to be presented, even after the device enters a locked or restricted access mode. For example, when a user does not interact with a smart phone, table, computer, etc. for a select period of time, the device goes to sleep. When in the restricted access mode, the user would otherwise need to enter a password or take other actions to unlock the screen or otherwise gain full access to the functionality of the device. In accordance with embodiments herein, the ICM application 224 continues to present a current content subsection(s) to the user while the device is in the restricted access mode, thereby allowing the user to continue through the instructions (e.g., cooking, repairing a vehicle, performing a home improvement, etc.) without repeatedly needing to unlock the device. Even after the device enters a locked state, the user may speak a request for prior or future instructions.

At 310, the one or more processors of the device determine whether a request has been received for the next content subsection (within the series of content subsections). For example, the user may verbally request the next instruction to be provided (e.g., “What is next”, “Provide the next instruction”), or otherwise provide an indication for the next instruction. Additionally or alternatively, the processor may determine to provide the next instruction without a prompt from the user. For example, the next instruction may be presented after waiting a predetermined period of time. Additionally or alternatively, the device may question the user as to whether the user is ready for the next instruction (e.g., “Are you ready to continue”, “Did you add the rice”).

When the next subsection is requested at 310, flow advances to 314. Otherwise flow moves to 312. At 314, the next content subsection within a set of content subsections is obtained and presented at 308. When flow advances to 312, the one or more processors of the device determine whether a request has been made for another (out of order) content subsection (other than the next content subsection). For example, a user may ask to skip ahead to a later content subsection, such as when the user performs multiple activities in a row without stepping through the corresponding instructions. Additionally or alternatively, the user may ask to have a prior instruction repeated. When a request for another subsection has been made at 312, flow advances to 316. Otherwise flow moves to 318.

At 316, the corresponding content subsection is identified. For example, the user may make a request (e.g., verbally spoken, through the GUI) for a prior instruction to be repeated. In response, the processor may analyze the request and identifies the corresponding content subsection. For example, the user may ask “What do I do after I have seasoned the chicken?”, or “When do I add the beans”, and the like. To perform the identification, the processor may identify one or more terms of interest from the request and match the request term(s) of interest to one or more matching terms within a content subsection. When a corresponding content subsection is identified, flow returns to 308 where the corresponding content subsection is repeated.

As another option at 316, the user may provide a request for a specific content subsection, such as indicating to repeat the “last” instruction. As another example, the user may indicate to repeat “The first instruction”, “The next instruction”, “Go back 2 instructions”, etc. When a specific prior or forward instruction is requested, the processor may not perform a detailed analysis. Instead, the processor may simply step backward or forward by the corresponding number of content subsections to reach the designated content subsection.

Returning to 312, when no content subsection is requested, flow moves to 318. At 318, the one or more processors of the device determine whether the process has ended, such as when all of the instructions have been presented. As another example, the user may terminate presentation of the instructions prematurely by turning off the device, deactivating the ICM application, providing a spoken instruction to stop instructional support mode and the like. When the process continues, flow returns to 308 where the present content subsection is continuously presented until another instruction is received.

In accordance with embodiments herein, the process of FIG. 3 affords presentation of the content subsections from the instructional content in a user directed manner. The user defined manner introduces a delay between presenting first, second, third, etc. content subsections from the set of content subsections. A duration of the delay is based on the user request. The process steps to presentation of then, prior, future content subsection in response to the user request.

As explained herein, in general sets of content subsections are organized in a predetermined order (e.g., action #1, action #2, action #3, etc.). In accordance with the user directed manner of FIG. 3, the user is afforded control over when to present a particular content subsection and which content subsection of interest should be presented. The user is allowed to designate any content subsection of interest from the set of the content subsections, with the content subsection of interest being presented in order or out of order based on the user request.

Next, processes are described in connection with identifying activation events that are used to direct the ICM application 224 to enter the instructional support mode.

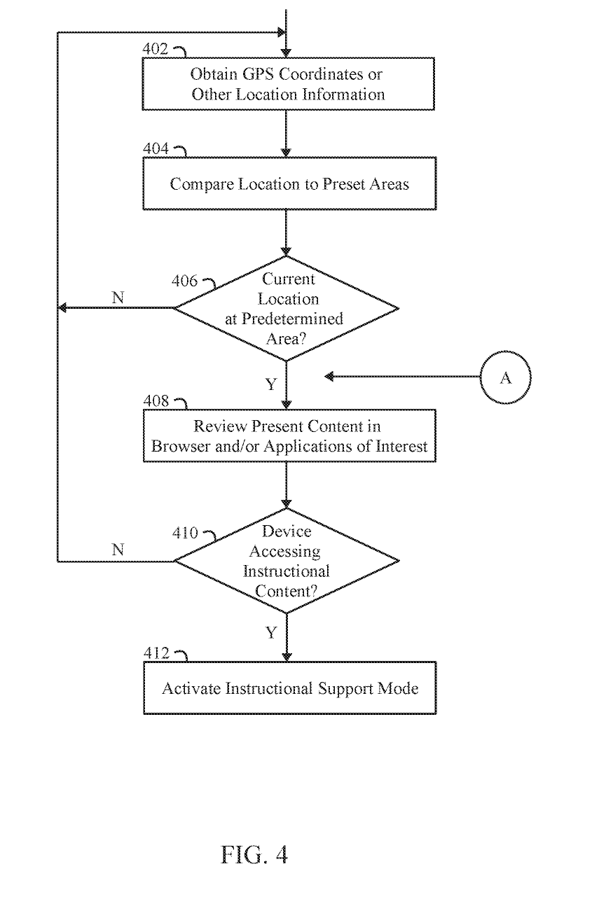

FIG. 4 illustrates a process for determining when to activate an instructional support mode based on GPS information and browser content in accordance with embodiments herein. The operations of FIG. 4 are carried out by one or more processors 204 of the device 110 in response to execution of program instructions, such as in the ICM application 224, and/or other applications stored in the memory 206.

At 402, one or more processors of the device obtains location information. For example, a GPS module within the device may be utilized to obtain GPS coordinates. Additionally or alternatively, the device may determine a location relative to other sensory inputs, such as when the device is within range of a home router Wi-Fi network. Additionally or alternatively, the device may determine location based on image detection through the camera (e.g., the device recognizes from an image capture, that the device is in the kitchen, in the garage, etc.).

At 404, one or more processors of the device compare the location information to region location data for one or more predetermined areas. For example, when utilizing GPS coordinates, the processor(s) may determine when the present position of the device is within the boundaries of an area in a house (e.g., kitchen, garage, backyard, or study area). Optionally, the processor(s) may determine when the present position of the device is within a predetermined range of a reference coordinate point. Optionally, the predetermined area may correspond to a Wi-Fi range of a home router, prerecorded images of areas within the home, and the like. Optionally, the device may communicate with a home security system and determine that motion has been detected in a kitchen or garage area. When the device communicates with the home security system to identify motion in the predetermined areas, the device may use the foregoing information in connection with establishing the device location.

At 406, the one or more processors determine whether the current location is within the predetermined area. When the location is within a predetermined area, flow moves to 408. Otherwise, flow returns to 402 and new location information is obtained.

At 408, when the current location of the device is within a predetermined area, the one or more processors review the content currently being accessed on the device. For example, when a browser is open on the device, at 408, the displayed content is reviewed. Additionally or alternatively, when one or more applications (e.g., applications capable of providing instructional content) are open, the current content is reviewed.

At 410, the one or more processors determine whether the browser and/or application is accessing instructional content. As explained herein, the determination of whether instructional content is being reviewed may be determined in various manners. For example, the current HTTP address or domain may be compared with the list of instructional resources 214 (FIG. 2) saved in memory 206. Optionally, a key word search may be performed upon a current webpage being displayed. At 410, when the processor determines that the device is not accessing instructional content, flow returns to 402. Otherwise, flow advances to 412. At 412, the processor activates the instructional support mode, which is described above in connection with FIG. 3.

In the example of FIG. 4, the position information and the browser content are used in combination to determine whether to activate the instructional support mode. Optionally, either of the position information or the browser content may be used alone, or in combination with alternative information, to determine whether to activate the instructional support mode.

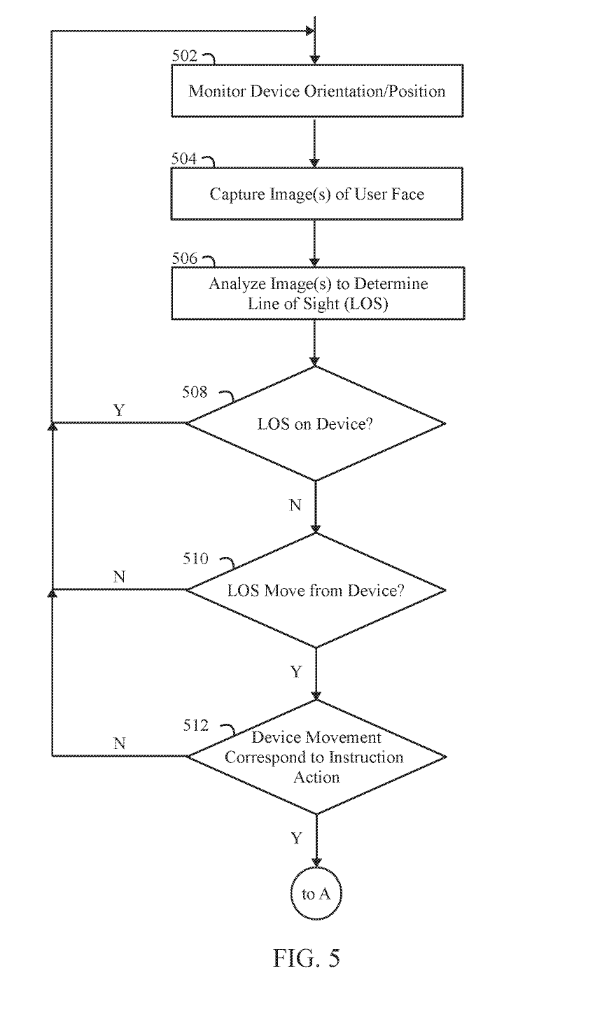

FIG. 5 illustrates an alternative process for determining whether to activate an instructional support mode based on device position and gaze events in accordance with embodiments herein. The operations of FIG. 5 are carried out by one or more processors 204 of the device 110 in response to execution of program instructions, such as in the ICM application 224, and/or other applications stored in the memory 206.

At 502, the one or more processors monitor the position and/or orientation of the device. For example, the position and orientation may be monitored through the use of an accelerometer within the device. The accelerometer data may be used to detect that the device is positioned on a side or end edge (e.g., when set on edge to view remotely). Optionally, the accelerometer data may be used to detect that the device is moved through a predetermined gesture pattern.

Additionally or alternatively, the camera within the device may be used to capture an image that is used to determine the position and/or orientation of the device (e.g., by comparing a still frame with prerecorded images of a kitchen, garage, etc.). Other components may be utilized to determine position and orientation.

The operations at 504-510 are implemented in connection with the camera within the device to perform gaze detection. The operations at 504-510 detect a gaze event indicating that a user has been viewing content on the display. For example, the method utilizes the digital camera unit to capture still or video images, and uses the processor to analyze the still or video images, as explained herein in connection with FIG. 5, to identify when a user begins to initially look at the display (referred to as gaze engagement) and when a user looks away from the display (referred to as gaze termination).

Optionally, gaze event detection may be combined with additional inputs from the user. For example, the method may, in addition to detecting a gaze event, also determine when the user enters one or more predefined touch gestures through the user interface and/or voice commands through a microphone on the device 110. The predefined touch gestures and/or voice command may provide additional information, such as regarding execution of control features.

As one example, at 504, the camera captures one or more images of a user's face. At 506, the processor analyzes the images to determine the user's present line of sight. At 508, the processor determines whether the user's present line of sight is directed at the display of the device. When the user's present line of sight is directed at the display of the device, flow returns to 502. Otherwise, flow advances to 510.

At 510, the one or more processors of the device determine whether the user's line of sight has moved away from the device display. For example, at 510, when a user's present line of sight is determined to be directed away from the device, prior image frames are analyzed to determine whether the user was previously viewing the device display. From a series of images, the processor can determine that the user was previously reviewing the content of the display, but is no longer doing so. If the decision at 510 determines that the user moved the line of sight away from the device, flow returns to 502. However, when the decision at 510 determines that the user redirected the line of sight away from the device, flow advances to 512. From the foregoing sequence of operations, the device may determine that the user was reviewing the content of the display but is no longer.

At 512, the one or more processors of the device determines whether the device has been moved in a predetermined manner that corresponds to activation of an instructional support mode. For example, the position and orientation information collected at 502, may be compared over a period of time. From the position and orientation information, the processor may determine that the device has been set down on a stationary position and not moved for a period of time. As another example, the position and orientation information may indicate that the device has been propped up on an edge (e.g., when a user wishes to view the display while performing another activity, such as cooking or repairing an item). As another example, the position and orientation information may indicate that the user has moved to the device through a predetermined gesture pattern. For example, one or more predetermined gesture patterns may be defined that, when performed, represent an indication from the user that the user desires to activate the instructional support mode. For example, a gesture pattern may represent a stirring motion of the device, movement of the device acting forth in a particular manner or at a particular rate, rotating the device in a predetermined manner or a predetermined number of rotations. It is recognized that numerous other gesture patterns may be defined, automatically in advance or recorded by the user in order to tailor the gesture pattern to the individual user.

At 512, when it is determined that no movement has occurred that would indicate activation of an instructional support mode, flow returns to 502. However, when the movement does indicate that the instructional support mode should be activated, flow moves to point A in FIG. 4. As described above in connection with FIG. 4, the operations for reviewing content are repeated.

It is recognized that the examples of FIGS. 4 and 5 represent various criteria that may be utilized to determine when to initiate an instructional support mode. Optionally, different portions of the operations of FIGS. 4 and 5 may be used as the basis to activate an instructional support mode. For example, the instructional support mode may be activated based solely (or in combination with one or more of the other criteria) on movement of a device (corresponding to the operations at 502 and 512). Additionally or alternatively, the instructional support mode may be activated based solely (or in combination with one or more of the other criteria) on the gaze detection and of the determination of whether the user has moved their line of sight away from the device. Additionally or alternatively, the instructional support mode may be activated based solely (or in combination with one or more of the other criteria) on the location of the device and/or solely on when instructional content is being reviewed on the device.

The device may broadly encompass any type of system or device, on which instructional content is presented. The device may represent a computing device, an electronic device, equipment or other non-computing device, etc. The device may represent a computer, tablet, phone, smart watch and the like. The foregoing examples, describe the device application in connection with applications operating on a portable device, although the present disclosure is not limited to such applications. Instead, the device may be useful in various other applications, such as within an automobile, an airplanes, smart home or commercial appliances, home or industrial equipment, etc.

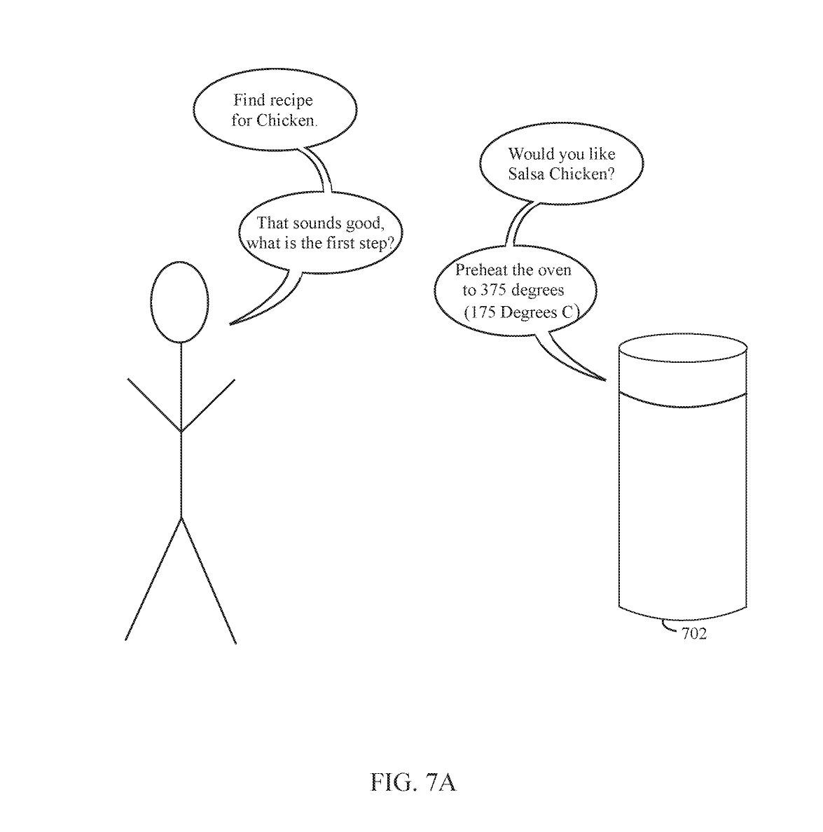

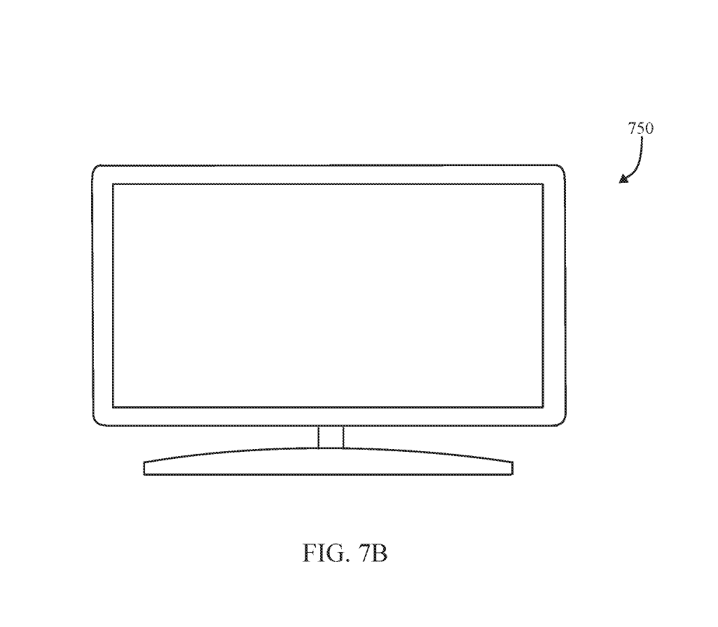

FIGS. 7A-7B illustrate alternative embodiments in which the methods and devices described herein are implemented in connection with various types of devices. FIG. 7A illustrates an electronic device 702 that may not include a touch screen or display, but instead primarily verbally interacts with the user. For example, the device 702 may represent a voice-enabled wireless network-based device that is capable of voice interaction. Continuing with the present example, a user may provide a request to find a recipe for a particular type of food, such as “Find a recipe for chicken.” The device 702 may perform a search of available on-line or stored resources for the requested recipe and respond “Would you like salsa chicken?” The user may accept the recipe, such as by indicating “That sounds good, what is the first step?” In response, the device 702 may begin by providing each instruction within the recipe as separate content subsections in accordance with the operations described herein, such as “Preheat the oven to 375°.”

A voice-enabled wireless devices is one example of the type of device the may be implemented in connection with embodiments herein. As another example, FIG. 7B illustrates a device 750 that may represent a television or other audio/visual electronic device.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the FIGS., which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A computer implemented method comprising:
identifying instructional content utilizing one or more processors of a device;
parsing the instructional content to identify a set of content subsections;
receiving, through a user interface of the device, a user request associated with the set of content subsections; and
presenting at least a portion of the set of content subsections, through a user interface of the device, in a user directed manner based on the user request.

2. The method of claim 1, further comprising displaying the instructional content on a display of an electronic device, wherein the automatically identifying comprises analyzing the instructional content being displayed, utilizing one or more processors of the device.

3. The method of claim 1, wherein the user directed manner includes introducing a delay between presenting first and second content subsections from the set of content subsections in response to the user request.

4. The method of claim 1, wherein the set of content subsections are organized in a predetermined order, and wherein the user directed manner includes designating a content subsection of interest from the set of the content subsections, the content subsection of interest being presented out of order based on the user request.

5. The method of claim 1, wherein the user request designates a content subsection of interest from the set of content subsections to be repeated outside of a predetermined order.

6. The method of claim 1, wherein the parsing comprises applying a filter to the instructional content to identify the set of content subsections.

7. The method of claim 1, further comprising activating an instructional support mode based on one or more activation events, the parsing, receiving and presenting being performed during the instructional support mode, wherein the one or more activation events comprises determining whether a location of the device corresponds to a predetermined area, the instructional support mode activated based on the determining.

8. The method of claim 1, further comprising activating an instructional support mode based on one or more activation events, the parsing, receiving and presenting being performed during the instructional support mode, wherein the one or more in activation events comprises identifying whether the device is presenting at least a portion of the instructional content, the instructional support mode activated based on the identifying.

9. The method of claim 1, further comprising activating an instructional support mode based on one or more activation events, the parsing, receiving and presenting being performed during the instructional support mode, wherein the one or more activation events comprises identifying a user gaze relative to the display of the device, the instructional support mode activated based on the identifying.

10. A device, comprising:
a processor;
memory storing program instructions accessible by the processor;
wherein, responsive to execution of the program instructions, the processor:
identifies instructional content utilizing one or more processors of the device;
parses the instructional content to identify a set of content subsections;
receives a user request associated with the set of content subsections; and
presents at least a portion of the set of content subsections, through a user interface of the device, in a user directed manner based on the user request.

11. The device of claim 10, further comprising a display configured to display the instructional content, wherein the processor is configured to analyze the instructional content being displayed.

12. The device of claim 10, wherein the processor introduces a delay between presenting first and second content subsections from the set of content subsections, a duration of the delay based on the user request.

13. The device of claim 10, wherein the processor is configured to organize the set of content subsections in a predetermined order, and the processor is configured to present a content subsection of interest from the set of content subsections out of order based on the user request.

14. The device of claim 10, wherein the user request designates a content subsection of interest from the set of content subsections to be repeated outside of a predetermined order, the processor configured to repeat the content subsection of interest.

15. The device of claim 10, further comprising a GPS chipset configured to determine a location of the device, the processor configured to determine when the location of the device corresponds to a predetermined area associated with activating an instructional support mode.

16. The device of claim 10, further comprising a camera configured to obtain image data frames, the processor configured to identify a user gaze relative to a display of the device based on the image data frames and activate an instructional support mode based on the user gaze.

17. A computer program product comprising a non-signal computer readable storage medium comprising computer executable code to perform:
identifying instructional content utilizing one or more processors of a device;
parsing the instructional content to identify a set of content subsections;
receiving, through a user interface of the device, a user request associated with the set of content subsections; and
presenting at least a portion of the set of content subsections, through a user interface of the device, in a user directed manner based on the user request.

18. The computer program product of claim 17, further comprising a list of instructional resources representing network locations that provide instructional content for one or more types of activities, the instructional content automatic identified by comparing an accessed resource to the list of instructional resources.

19. The computer program product of claim 17, further comprising region location data defining one or more predetermined areas that are designated as active instructional support areas.

20. The computer program product of claim 17, wherein the set of content subsections are organized in a predetermined order, and wherein the user directed manner includes designating a content subsection of interest from the set of the content subsections, the content subsection of interest being presented out of order based on the user request.
